(19) United States
(12) Patent Application Publication
(10) Pub. No.: US 2024/0165739 A1
(43) Pub. Date: May 23, 2024

(54) METHOD AND DEVICE FOR POWDER INJECTION MONITORING DURING LASER BEAM BUILDUP WELDING

(71) Applicant: TRUMPF Laser- und Systemtechnik GmbH, Ditzingen (DE)

(72) Inventors: Benedikt Wessinger, Kaempfelbach (DE); Marco Opitz, Waldstetten (DE); Bjoern Sautter, Leonberg (DE); Nicolai Speker, Pleidelsheim (DE); Tim Hesse, Ditzingen (DE)

(21) Appl. No.: 18/423,350

(22) Filed: Jan. 26, 2024

Related U.S. Application Data
(63) Continuation of application No. PCT/EP2022/072251, filed on Aug. 8, 2022.

(30) Foreign Application Priority Data
Aug. 11, 2021 (DE) 10 2021 208 745.0

(51) Int. Cl. B23K 26/144; B22F 12/41; B22F 12/90; B23K 26/035; B23K 26/342; B33Y 50/02

(52) U.S. Cl. CPC B23K 26/144; B22F 12/41; B22F 12/90; B23K 26/035; B23K 26/342; B33Y 50/02

(57) ABSTRACT

A method for powder injection monitoring during laser beam buildup welding includes irradiating a workpiece using a work laser beam, conveying powder through at least one powder nozzle to generate a powder jet, illuminating the powder jet transversely to a jet direction of the powder jet, and taking at least one picture of the powder jet by using a camera. A viewing direction of the camera extends coaxially to the jet direction of the powder jet. The method further includes performing an actual assessment of the at least one picture by an algorithm, and outputting a message upon determining that a predefined deviation of the actual assessment from a target assessment is exceeded.

### CROSS REFERENCE TO RELATED APPLICATIONS

This application is a continuation of International Application No. PCT/EP2022/072251 (WO 2023/016993 A1), filed on Aug. 8, 2022, and claims benefit to German Patent Application No. DE 10 2021 208 745.0, filed on Aug. 11, 2021. The aforementioned applications are hereby incorporated by reference herein.

### FIELD

Embodiments of the present invention relate to a method for powder injection monitoring during laser beam buildup welding, and to a device for carrying out a method for powder injection monitoring.

### BACKGROUND

Determining the properties of a powder jet is known, see, for example, the yearly report of the Fraunhofer Institute for Laser Technology ILT 2011. This yearly report is known to the applicant, but such prior art may also be internal and unpublished. Furthermore, a method for powder injection monitoring is known from U.S. Pat. No. 5,396,333 A. However, the known methods have the risk that method errors will not be noticed in a timely manner.

### SUMMARY

Embodiments of the present invention provide a method for powder injection monitoring during laser beam buildup welding. The method includes irradiating a workpiece using a work laser beam, conveying powder through at least one powder nozzle to generate a powder jet, illuminating the powder jet transversely to a jet direction of the powder jet, and taking at least one picture of the powder jet by using a camera. A viewing direction of the camera extends coaxially to the jet direction of the powder jet. The method further includes performing an actual assessment of the at least one picture by an algorithm, and outputting a message upon determining that a predefined deviation of the actual assessment from a target assessment is exceeded.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a device for powder injection monitoring during laser beam buildup welding according to some embodiments; and

FIG. 2 schematically shows a method for powder injection monitoring during laser beam buildup welding according to some embodiments.

### DETAILED DESCRIPTION

Embodiments of the invention provide a method for monitoring the powder injection so it is safer. Embodiments of the invention also provide a device for safely carrying out a method for powder injection monitoring.

According to embodiments of the invention, the method comprises the following method steps:
A) irradiating a workpiece using a work laser beam;
B) conveying powder through at least one powder nozzle and thus generating a powder jet;
C) illuminating the powder jet transversely to the jet direction of the powder jet;
D) taking a picture of the powder flow by way of a camera, wherein the viewing direction of the camera extends coaxially to the jet direction of the powder jet;
E) actual assessment of the picture by an algorithm;
F) outputting a message if a predefined deviation of the actual assessment from a target assessment is exceeded.

The method according to embodiments of the invention allows reliable powder injection monitoring, in particular monitoring of the powder caustic. A clog, wear, and/or change of the nozzle geometry can be recognized and remedied early by outputting the message. By reporting the deviation of an actual assessment from a target assessment of an illuminated measurement zone of the powder jet, in particular undesired changes of the powder jets, inter alia, due to soiling, melting, or mechanical defects such as damage to outlet openings of powder injectors of the powder nozzle, can be reported upon their occurrence to a user of the method. The user can then remedy the fault which has resulted in the change or can end the method to avoid damage. The monitoring (method steps E) and F)) can be carried out in parallel in time to the powder injection and measurement (method steps A) to D)), in particular online.

The evaluation of the properties of the powder jet is carried out in particular using an evaluation unit for image data processing and a position-resolving detector in the form of the camera. The camera is preferably arranged in the beam path of the work laser beam. The camera is preferably positioned in the powder nozzle having the viewing direction along the powder jet, which propagates in a jet direction. The powder particles in the illuminated measurement zone of the powder jet reflect a part of the radiation of the illumination in a direction counter to the flow direction of the powder flow. The illuminated measurement zone is preferably the caustic of the powder jet. Good contrast is thus achieved. The reflected radiation is incident on the camera, which is arranged upstream of the illuminated measurement zone of the powder jet in the flow direction of the powder flow. The camera then detects a cross section of the powder jet. In particular, powder jets of individual injectors of the powder nozzle can be made visible. Each powder jet is characterized by the data from the measurement zone by suitable algorithms. A warning message or error message is output in the event of undesired properties of the individual powder jets.

Among other things, the position of the focus of the powder jet in relation to the nozzle orifice can be measured using the method. The offset from the powder jet to the work laser beam can also be determined. The offset of the centre point of the focus of the work laser beam and the focus of the powder jet can preferably be measured.

The illumination in method step C) preferably takes place perpendicularly ±30°, in particular perpendicularly ±20°, preferably perpendicularly ±10° to the beam direction of the powder jet. The powder mass flow is, depending on the application, preferably in a range of at least 1 g/minute, preferably at least 5 g/minute, and up to 500 g/minute, preferably up to 250 g/minute. Two or more powder jets can be used. The illumination duration is in particular 10 ms or more. The angle between the longitudinal axes of the powder injectors and the longitudinal axis of the body of the powder nozzle is preferably less than 45°. In some embodiments of the method, two or more work lasers are each used to emit one work laser beam.

In particular the flow of the powder particles which are emitted from the powder nozzle is designated as the powder jet. A powder flow is to be understood here in particular as the flow of the powder jet. The powder jet generally comprises a gas and is also designated as a powder-gas jet. A work laser beam is understood in particular as a suitable electromagnetic wave which is emitted from a laser source in the form of the work laser. An illumination (laser) beam for illuminating the powder jet is generally formed as an electromagnetic wave emitted by the illumination device.

In a first embodiment of the method, the message is output in the form of a warning message and/or in the form of an error message. The warning message in particular takes place acoustically and/or optically. A user of the method is thus warned in a simple manner in the event of a deviation of the actual assessment from the target assessment. An error message in particular gives the user more accurate information about the type of the deviation and/or possible causes of the deviation.

In a further embodiment of the method, the powder conveyance in method step B) takes place through multiple powder nozzles. The powder conveyance thus takes place in a more spatially uniform manner than it does with only one powder nozzle.

In one advantageous embodiment of the method, the illumination of the powder jet in method step C) is carried out by a line laser. If a line laser is used, the position of the illuminated zone is precisely determined by the plane in which the line laser beam intersects the powder jet. In the event of an illumination perpendicular to the direction of the powder jet, the illuminated zone has a small extension in the direction along the powder jet. This results in a good measurement resolution. Cross sections of the powder jet can be measured in individual planes using the line laser, for example, a red line laser. For example, the plane in which the focus of the powder jet lies can be deliberately selected. The line laser can illuminate through the powder jet in its cross section, in order to completely analyse the cross section using only one laser beam in this manner.

Alternatively or additionally thereto, the illumination of the powder jet is carried out in method step C) by a spotlight and/or a ring light. An illumination having an extension in all spatial directions can be produced by such (laser) beams. A comparatively large volume of the powder jet can be detected for analysis, in particular the entire caustic of the powder jet. A (laser) beam has a comparatively high intensity in these embodiments, which enables short exposure times.

In one variant of the method, the illumination of the powder jet in method step C) is carried out by at least one light-emitting diode. In particular, a light-emitting diode is suitable for emitting a light-emitting diode spot laser beam for illuminating the powder jet. Light-emitting diodes are additionally distinguished by a long service life and a compact design.

In one preferred form of the method, the illumination of the powdered jet in method step C) is reflected antiparallel. The radiation for illuminating a measurement zone of the powder jet passes through the measurement zone and is then reflected, whereupon it passes through the measurement zone again. In particular, a uniform illumination of the measurement zone is thus effectuated.

In one refinement of the above-mentioned form of the method, the antiparallel reflection is carried out by a deflection prism, a deflection mirror, and/or a retroreflector. These components may be arranged in a ring shape around the powder jet, in order to effectuate uniform illumination of the illuminated measurement zone of the powder jet by multiple reflections using only one illumination source. If these components are used, the power of the illumination beam source for illuminating the powder jet can be selected to be comparatively low. The retroreflector is designed in particular as a 90° retroreflector. The entirety of the components in the method is designated here collectively as a deflection optical unit.

In one advantageous embodiment of the method, the illumination in method step C) takes place in the focus of the powder jet. In particular, it can be checked here whether the location of this focus in relation to the orifice of the powder nozzle and thus the alignment of the powder jet corresponds to the specifications. It can also be measured how large the offset of the focus of the powder jet to the focus of the work laser beam is. A deformation of the powder jet can be established on the basis of a deformation of the focus of the powder jet.

A further embodiment of the method is distinguished in that the illumination in method step C) takes place directly below the at least one powder nozzle. A uniform exit of the powder jet from the orifice of the powder nozzle is checked in this case. Injection wear can thus be established. In particular, individual powder jets which exit from injectors of the powder nozzle can be examined.

One advantageous variant of the method is characterized in that the illumination in method step C) takes place in multiple illumination planes. The illumination planes preferably extend in the focus of the powder jet and directly below the at least one powder nozzle. The information of the measurement from the various planes can be combined to obtain statements on the course of the powder jet from the nozzle orifice to the focus.

According to a further variant, method step D) comprises taking multiple chronologically successive pictures. This can preferably comprise the creation of one or more film sequences.

In addition, method step E) can comprise an actual evaluation of the chronological sequence of pictures, wherein preferably a characteristic value is determined that indicates a (chronological) change of the powder flow. The chronological change of the powder flow can comprise, for example, a position change of the powder jet or a change of the particle density of the powder jet in the plane of the pictures. Method step F) can in these cases comprise a comparison of the determined characteristic value to a target value for the powder flow. If the determined characteristic value deviates by more than a pre-determinable maximum deviation (limit value) from the target value for the powder flow, a message can be output (for example, in the form of a warning signal). Due to the measurement and assessment of the changes of the powder flow, for example, “dancing” (i.e., position shifts) of the powder jet, periodic “spitting” of the powder nozzle (i.e., irregularities of the powder mass flow), or other undesired dynamic appearances of the powder flow over the recording period of time can be detected and countermeasures can be taken if necessary.

A further variant of the method comprises the following method step:
G) automated alignment of the focus of the powder jet on the focus of the work laser beam.

The automated alignment can be carried out on the basis of the measurement results obtained in the scope of the method. The automated alignment makes a contribution to homogeneous melting of the powder.

One preferred embodiment of the method is characterized in that the beam direction of the work laser beam extends coaxially to the jet direction of the powder jet. This promotes homogeneous melting of the powder in the desired area of a workpiece.

According to a further aspect of the invention, a method for laser beam buildup welding having the following features is provided: B2) switching on a powder conveyance through at least one powder nozzle and thus generating a powder jet; C2) illuminating the powder jet transversely to the jet direction of the powder jet; D2) taking multiple chronologically successive pictures of the powder flow by way of a camera, wherein the viewing direction of the camera extends coaxially to the jet direction of the powder jet; E2) actual assessment of the pictures, wherein a characteristic value is determined which indicates a change of the powder flow; F2) comparing the determined characteristic value to a target value for the powder flow; G2) starting a laser beam buildup welding process using a work laser beam as soon as the comparison according to step F2) shows that the powder flow is within predetermined tolerance limits for the target value.

The assessment of the powder flow can thus be used to wait for a stabilization of the powder flow before beginning a laser beam buildup welding process. As soon as the powder flow has stabilized, the buildup welding process can be started. In this way, a weld bead can be created from the beginning with uniform quality, wherein the waiting time to prepare for the buildup welding process is minimized at the same time.

According to one variant of the method, it can be provided that the work laser beam is first switched on when the powder flow is within the predetermined tolerance limits.

The method disclosed here for preparing for a laser beam buildup welding process is combinable with the method disclosed above for powder injection monitoring during the laser beam buildup welding.

A device for powder injection monitoring during the laser beam buildup welding, in particular for carrying out a method according to any one of the preceding claims, comprises the following:
a) a work laser for generating a work laser beam;
b) at least one powder nozzle for generating a powder jet;
c) an illumination device for illuminating the powder jet transversely to the jet direction of the powder jet;
d) a camera for taking a picture of the powder flow, wherein the viewing direction of the camera extends coaxially to the beam direction of the work laser beam;
e) a computer having an algorithm for the actual assessment of the picture by the algorithm;
f) an output device for outputting a message if a predefined deviation of the actual assessment from a target assessment is exceeded.

Such a device enables a rapid warning to a user of the device when the powder jet does not have the desired properties.

A first embodiment of the device comprises the following:
g) an alignment device for automated alignment of the focus of the powder jet on the focus of the work laser beam.

This improves the homogeneous melting of the powder in the desired area of a workpiece.

A further embodiment of the device is distinguished in that the illumination device is designed to illuminate the powder jet in multiple planes. The spatial course of the powder jet can thus be determined. The illumination device can be designed here to illuminate the powder jet both in the focus of the powder jet and also directly below the at least one powder nozzle.

Further advantages of the invention may be found in the description and the drawing. Likewise, according to the invention the features mentioned above and those yet to be explained further may respectively be used individually or together in any desired combinations. The embodiments shown and described should not be understood as an exhaustive list, but rather are of an exemplary character for outlining the invention.

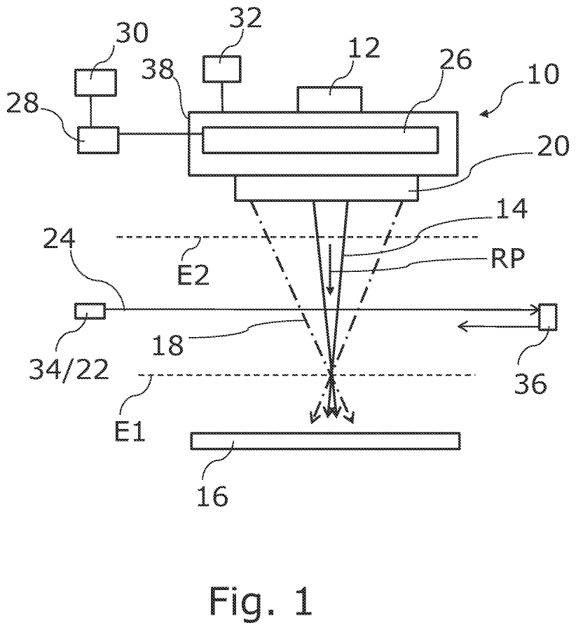

FIG. 1 schematically shows a device 10 for powder injection monitoring during laser beam buildup welding. A work laser 12 is used to generate a work laser beam 14 for irradiating a workpiece 16. A powder jet 18 is generated by a powder nozzle 20. The powder jet 18 is illuminated by an illumination device 22, designed in particular as a light-emitting diode 34, in a section of the powder jet 18 using an illumination (laser) beam 24. The illumination (laser) beam 24 extends perpendicularly to the direction of the powder jet 18. For homogeneous illumination of the powder jet 18 in the illuminated measurement zone, the illumination (laser) beam 24 is reflected antiparallel by a deflection optical unit 36, wherein the deflection optical unit 36 in particular has a deflection prism, a deflection mirror, and/or a retroreflector. To determine the spatial course of the powder jet 18, the illumination preferably takes place in a plane E₁ which extends through the focus of the powder jet 18 and/or the work laser beam 14 and/or a plane E₂ arranged close to the powder nozzle 20.

A camera 26 in a housing 38 of the device 10 takes pictures of the powder jet 18, wherein the viewing direction of the camera 26 extends coaxially to the jet direction RP of the powder jet 18, which coincides here with the beam direction of the work laser beam 14. An algorithm, which assesses the picture by the camera 26 using an actual assessment, is installed on a computer 28. An output device 30 is used to output a message if a predefined deviation of the actual assessment from a target assessment is exceeded. The focus of the powder jet 18 can be aligned on the focus of the work laser beam 12 by an alignment device 32.

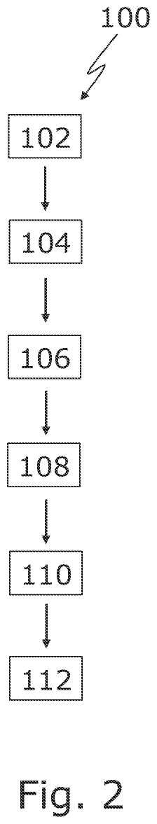

FIG. 2 schematically shows a method 100 for powder injection monitoring during laser beam buildup welding. In the method, in a first step 102, the workpiece 16 is irradiated using a work laser beam 14. In a second step 104, a powder jet 18 is generated, wherein the powder for the powder jet 18 is conveyed through a powder nozzle 20. The powder jet 18 is illuminated in a third step 106 transversely to the jet direction of the powder jet 18. In a fourth step 108, a picture of the illuminated section of the powder jet 18 is taken by a camera 26. The viewing direction of the camera 26 extends here coaxially to the jet direction of the powder jet 18. Above-mentioned steps 102 to 106 take place simultaneously. In a fifth step 110, an algorithm carries out an actual assessment of the picture. In a sixth step 112, a message is output if the actual assessment deviates from the target assessment by a predetermined amount.

As described above, embodiments of the invention relate to powder injection monitoring during laser beam buildup welding. During the powder injection monitoring, a powder jet 18 is guided from a powder nozzle 20 onto a workpiece 16. The powder in the powder jet 18 is fused with the workpiece 16 by a work laser beam 14, which is radiated onto the workpiece 16. The powder jet 18 is illuminated by an illumination (laser) beam 24 perpendicular to the direction of the powder jet 18. A camera 26 having a viewing direction which extends parallel to the jet direction of the powder jet 18 images the section of the powder jet 18 illuminated by the illumination (laser) beam 24. The above-mentioned steps take place simultaneously here. An algorithm carries out an actual assessment of the illuminated section of the powder jet 18. If the actual assessment deviates in a predetermined amount from a target assessment, a message is output.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 device
12 work laser
14 work laser beam
16 workpiece
18 powder jet
20 powder nozzle
22 illumination device
24 illumination (laser) beam
26 camera
28 computer
30 output device
32 alignment device
34 light-emitting diode
36 deflection optical unit/retroreflector
38 housing
E1, E2 illumination planes
RP jet direction of the powder jet

1. A method for powder injection monitoring during laser beam buildup welding, the method comprising the following simultaneously occurring steps:
A) irradiating a workpiece using a work laser beam;
B) conveying powder through at least one powder nozzle to generate a powder jet;
C) illuminating the powder jet transversely to a jet direction of the powder jet; and
D) taking at least one picture of the powder jet by using a camera, wherein a viewing direction of the camera extends coaxially to the jet direction of the powder jet;
the method further comprising the following steps:
E) performing an actual assessment of the at least one picture by an algorithm; and
F) outputting a message upon determining that a predefined deviation of the actual assessment from a target assessment is exceeded.

2. The method according to claim 1, wherein the message is output as a warning message and/or as an error message.

3. The method according to claim 1, wherein the powder is conveyed through multiple powder nozzles.

4. The method according to claim 1, wherein the illumination of the powder jet is performed by using at least one of a line laser, a spotlight, or a ring light.

5. The method according to claim 1, wherein the illumination of the powder jet is performed by using at least one light-emitting diode.

6. The method according to claim 1, wherein the illumination of the powder jet is reflected antiparallel.

7. The method according to claim 6, wherein the antiparallel reflection of the illumination of the powder jet is performed by using at least one of a deflection prism, a deflection mirror, or a retroreflector.

8. The method according to claim 1, wherein the illumination of the powder jet takes place in a focus of the powder jet.

9. The method according to claim 1, wherein the illumination of the powder jet takes place directly below at least one powder nozzle.

10. The method according to claim 1, wherein the illumination of the powder jet takes place in multiple illumination planes.

11. The method according to claim 1, wherein the taking of the at least one picture comprises taking multiple chronologically successive pictures.

12. The method according to claim 11, wherein the performance of the actual assessment of the at least one picture comprises performing the actual assessment of the multiple chronological successive pictures, to determine a characteristic value that indicates a change of the powder jet.

13. The method according to claim 1, further comprising the following step:
G) performing an automated alignment of a focus of the powder jet on a focus of the work laser beam.

14. The method according to claim 1, wherein a beam direction of the work laser beam extends coaxially to the jet direction of the powder jet.

15. A method for laser beam buildup welding comprising the following steps:
B2) switching on a powder conveyance through at least one powder nozzle to generate a powder jet;
C2) illuminating the powder jet transversely to a jet direction of the powder jet;
D2) taking multiple chronologically successive pictures of the powder jet by using a camera, wherein a viewing direction of the camera extends coaxially to the jet direction of the powder jet;
E2) performing actual assessment of the pictures to determine a characteristic value that indicates a change of the powder flow;
F2) comparing the determined characteristic value to a target value for the powder jet; and
G2) starting a laser beam buildup welding process using a work laser beam upon determining that the characteristic value of the powder jet is within predetermined tolerance limits from the target value.

16. The method according to claim 15, wherein the work laser beam is first switched on when the characteristic value of the powder jet is within the predetermined tolerance limits.

17. A device for powder injection monitoring during laser beam buildup welding, for carrying out a method according to claim 1, wherein the device comprises:
a) a work laser for generating the work laser beam;
b) at least one powder nozzle for generating the powder jet;
c) an illumination device for illuminating the powder jet transversely to the jet direction of the powder jet;
d) the camera for taking the at least one picture of the powder jet; and
e) a computer having the algorithm for the performance of the actual assessment of the at least one picture;
f) an output device for outputting the message upon determining that the predefined deviation of the actual assessment from the target assessment is exceeded.

18. The device according to claim 17, further comprising:
g) an alignment device for performing an automated alignment of a focus of the powder jet on a focus of the work laser beam.

19. The device according to claim 17, wherein the illumination device is configured to illuminate the powder jet in multiple planes.
